(19) United States
(12) Patent Application Publication
(10) Pub. No.: US 2004/0099029 A1
(43) Pub. Date: May 27, 2004

(54) Fertilizer and manufacturing method of the fertilizer

(76) Inventors: Takanobu Noda, Kasugai-shi (JP); Hirofumi Honda, Kasugai-shi (JP)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/691,878

(22) Filed: Oct. 23, 2003

(30) Foreign Application Priority Data
Oct. 25, 2002 (JP) 2002-311349

(51) Int. Cl. C05D 1/00

(52) U.S. Cl. 71/62

(57) ABSTRACT

A fertilizer with silica hydrogel as a main component in which the amount of water to be desorbed in accordance with the passage of time is less than in conventional fertilizers. The fertilizer is prepared using silica hydrogel obtained by reacting an alkali silicate solution and a mineral acid, and performing one of the following treatments: (1) Aging under the conditions of a pH range of pH 4-8 and a temperature range of 40-100° C. (2) Aging under the conditions of a pH range of pH 6-8 and a temperature range of 60-85° C. (3) Aging under the conditions of a pH range of pH 4-8 and a temperature range of 40-100° C., and then changing the pH range to pH 2-6. (4) Contacting with a solution containing one or more kinds of ions selected from the group consisting of iron ions, magnesium ions, calcium ions, aluminum ions and ammonia ions.

### BACKGROUND OF THE INVENTION

(1) Field of the Invention

This invention relates to a fertilizer and a method for manufacturing the fertilizer.

(2) Description of the Related Art

Conventionally, there are known silica gel-based fertilizers (for example, disclosed in Publication of Unexamined Japanese Patent Application No. 10-114588). The Publication includes a description that silica gel in any state, i.e., from silica hydrogel to silica xerogel, can be used as a main component of a fertilizer.

However, silica hydrogel which contains approximately 70-80% water is subject to desorption of a large amount of water after the passage of an extended time. The desorption leads to a problem that when a fertilizer containing such silica hydrogel as a main component is put into a packaging container, a large amount of water desorbed from silica hydrogel gathers at the bottom of the packaging container.

The large amount of desorbed water may flow out from the packaging container and wet the surrounding area depending on how the packaging container is opened. Of course, it may be possible to prevent the large amount of water from flowing out by carefully opening the packaging container. However, requiring so much care in a package opening operation will reduce the efficiency of this initial operation.

Furthermore, a large amount of water gathering at the bottom of the packaging container at the distribution or sales stage may undermine the product image of the fertilizer due to a misunderstanding that, for example, some change in quality of the fertilizer has occurred. To solve these problems, it is crucial to take effective measures to reduce the amount of water later desorbed from silica hydrogel as much as possible.

The present invention has been made to solve the above-mentioned problems. A major object of the present invention is to provide a fertilizer containing silica hydrogel as its main component in which the amount of water to be desorbed in accordance with the passage of time is less than in conventional fertilizers. Another object of the present invention is to provide a method for manufacturing the fertilizer.

### SUMMARY OF THE INVENTION

These and other objects are attained by a fertilizer conforming to the present invention. The fertilizer comprises, as a main component, a silica hydrogel obtained by reacting an alkali silicate solution and a mineral acid and subsequently performing aging under the conditions of a pH range of pH 4-8 and a temperature range of 40-100° C.

In another aspect of the invention, there is provided a fertilizer which comprises as a main component, a silica hydrogel obtained by reacting an alkali silicate solution and a mineral acid and subsequently performing aging under the conditions of a pH range of pH 6-8 and a temperature range of 60-85° C.

In a further aspect of the invention, there is provided a fertilizer which comprises, as a main component, a silica hydrogel obtained by reacting an alkali silicate solution and a mineral acid and subsequently performing aging under the conditions of a pH range of pH 4-8 and a temperature range of 40-100° C., and then changing the pH range to pH 2-6.

In yet another aspect of the invention, there is provided a fertilizer which comprises as a main component, a silica hydrogel obtained by reacting an alkali silicate solution and a mineral acid and subsequently contacting the obtained silica hydrogel with a solution containing one or more kinds of ions selected from the group consisting of iron ions, magnesium ions, calcium ions, aluminum ions and ammonia ions.

In another aspect of the invention, there is provided a fertilizer in which the silica hydrogel is wet pulverized to be in a paste state.

In a further aspect of the invention, there is provided a method of manufacturing a fertilizer by reacting an alkali silicate solution and a mineral acid and subsequently performing aging under the conditions of a pH range of pH 4-8 and a temperature range of 40-100° C. to obtain a silica hydrogel, and then preparing the fertilizer comprising the silica hydrogel as a main component.

In a yet further aspect of the invention, there is provided a method of manufacturing a fertilizer by reacting an alkali silicate solution and a mineral acid and subsequently performing aging under the conditions of a pH range of pH 6-8 and a temperature range of 60-85° C. to obtain a silica hydrogel, and then preparing the fertilizer comprising the silica hydrogel as a main component.

In another aspect of the invention, there is provided a method of manufacturing a fertilizer by reacting an alkali silicate solution and a mineral acid and subsequently performing aging under the conditions of a pH range of pH 4-8 and a temperature range of 40-100° C. to obtain a silica hydrogel, and further changing the pH range to pH 2-6, and then preparing a fertilizer comprising the silica hydrogel as a main component.

In a further aspect of the invention, there is provided a method of manufacturing a fertilizer by reacting an alkali silicate solution and a mineral acid and subsequently contacting the obtained silica hydrogel with a solution containing one or more kinds of ions selected from the group consisting of iron ions, magnesium ions, calcium ions, aluminum ions and ammonia ions to obtain a silica hydrogel, and then preparing the fertilizer comprising the silica hydrogel as a main component.

As the alkali silicate used for the above fertilizers and manufacturing methods of the fertilizers, all silicates, including sodium silicate and potassium silicate, may be used. However, it is preferable to use sodium silicate in order to manufacture the fertilizers at a lower cost. As for the mineral acid, all acids, including sulfuric acid, hydrochloric acid and nitric acid, may be used. However, it is preferable to use sulfuric acid to manufacture the fertilizers at a lower cost.

According to fertilizers in conformity to the present invention, silica hydrogel employed as the main component undergoes specific treatments, with the result that, unlike a conventional silica hydrogel from which a large amount of water is desorbed following the passage of time, relatively lower or negligible amount of water is desorbed from the treated silica hydrogel.

Specifically, when a conventional silica hydrogel manufactured as an intermediate product during the manufacturing process of a common silica gel, and after initial water drainage using a separatory funnel, a sieve, a filter, or the like, is left to stand for 48 hours, 5 or more weight percent of liquid component (mainly water) relative to its own weight measured immediately prior to standing, is desorbed. In contrast, when the silica hydrogel conforming to the invention is left to stand for 48 hours after initial water drainage, less than 5 weight percent of liquid component relative to its own weight measured immediately prior to standing is desorbed, or, in some cased, no measurable liquid component is desorbed.

Accordingly, even when a fertilizer with the silica hydrogel according to the invention as a main component is packed in a packaging container for a long period of time, a significant amount of water does not gather at the bottom of the packaging container. Without the possibility of a large amount of water flowing out of the packaging container when opened, an excessively cautious opening operation is not required, so that the efficiency of the opening operation may be increased. In addition, the product image of the fertilizer will not be undermined due to unwanted water gathering in the packaging container.

It is considered that desorption of liquid component is reduced in the fertilizer of the invention for the following reason. The structure of silica hydrogel can be divided into four layers, namely, SiO₂, surface OH group, an adsorbed water layer and a free water layer. When aging is performed under the conditions of a pH range of pH 4-8 and a temperature range of 40-100° C., H₂O in the free water layer, which is prone to be desorbed as water due to a structural feature of the silica hydrogel, is actually desorbed as water, with the result being that H₂O in the stable adsorbed water layer, which is reluctant to be desorbed as water, remains. Thus, the obtained silica hydrogel containing such a stable adsorbed water layer can prevent an additional desorption of a large amount of water.

The tendency for water desorption to be minimized is also enhanced when aging is performed under the conditions of a pH range of pH 6-8 and a temperature range of 60-85° C., which is preferable.

The tendency may be enhanced as well when aging is performed under the conditions of a pH range of pH 4-8 and a temperature range of 40-100° C., and additionally the altering the pH range to pH 2-6, which is also preferable.

It is considered that in the case of contacting the obtained silica hydrogel with a solution containing one or more kinds of ions selected from the group consisting of iron ions, magnesium ions, calcium ions, aluminum ions and ammonia ions, instead of performing aging, a water insoluble compound is generated on the surface of the silica hydrogel due to ion exchange between these ions and the silanor group and prevents water desorption so that a significant amount of water is not desorbed.

The above described fertilizer with silica hydrogel as a main component has a far greater silicic acid supply capacity than a known silicate-calcium fertilizer as well as a greater silicic acid supply capacity than a fertilizer with silica xerogel as a main component. Specifically, while silicic acid usually becomes saturated at 50 ppm to reach an equilibrium state in water in a neutral range, silica hydrogel reaches the above mentioned equilibrium state relatively more rapidly than any other silicate compounds. Therefore, even when fertilizing a plant in which the speed of absorbing silicic acid is extremely high, it is possible to stably supply sufficient amount of silicic acid by using the silica hydrogel.

The reasons why silica hydrogel demonstrates a greater silicic acid supply capacity than other silicate compounds are not definitively specified. However, one of the reasons which may be considered is that silica hydrogel has a relatively less stable structure consisting of silica when compared with silica xerogel and, therefore, allows silicic acid to more easily leach in water.

In silica hydrogel, unlike silica xerogel, water confined within the pores formed by the structure consisting of silica contains a relatively large amount of silicate monomers, which are easily discharged into water. This may be another reason why silica hydrogel demonstrates a greater silicic acid supply capacity.

When one of the above described fertilizers of the invention, in which the silica hydrogel provide a silicic acid supply source, is applied to farmland, the silicic acid can be absorbed efficiently by farm crops.

The fertilizer may be applied when watering farm crops by placing the fertilizer into a water supply tank, or by forcing water to pass through the fertilizer along the water's path from the water supply tank, in order to increase the silicic acid concentration of the water before application to the crops. When applied to a paddy field, the fertilizer may be placed at the water inlet to the paddy field, for example, by immersing a basket-like container or a net-like bag, containing the fertilizer therein, in the water at the water inlet.

In a hydroponic culture setting, water having an increased silicic acid concentration created in the same manner as described above may be supplied as a liquid fertilizer, and it also may be effective to place the above described fertilizer at the bottom of a hydroponic culture bed.

When the silica hydrogel is wet pulverized to form a paste substance, it is possible to inject the fertilizer directly into the ground using a device capable of injecting a paste substance. For example, it is possible to inject the fertilizer into the ground simultaneously with the planting of rice seedlings by using a rice planting machine.

Although the above described fertilizers contain silica hydrogel as the main component, it is to be understood that the fertilizers may contain multiple kinds of known fertilizer components in addition to the main component.

### BRIEF DESCRIPTION OF THE DRAWINGS

Preferred embodiments of the present invention will now be described with reference to the accompanying drawings; in which:

FIG. 1 is a graph showing the change in silicic acid concentration in a hydroponic culture solution; and

FIG. 2 is a graph showing the change in silicic acid content of seedlings in respective test sections.

### DETAILED DESCRIPTION OF THE PREFERRED EMBODIMENTS

[Embodiment 1]

Sodium silicate (Na₂O.xSiO₂, Molar Ratio x=3.3, SiO₂17 wt %) and 3.9N of sulfuric acid were continuously mixed to prepare silica hydrosol. The silica hydrosol turned to silica hydrogel by gelation. Subsequently, acid treatment using approximately 0.8N of sulfuric acid was performed on the obtained silica hydrogel in order to neutralize non-reacted alkali content. Then, the acid treated silica hydrogel was aged by water washing using water with a pH 7 at a temperature of 65° C., and at a flow rate of approximately 150 liter/min for 12 hours. The discharged water had pH 7 when the water washing procedure was finished.

1 kg of silica hydrogel produced according to the above conditions was put into a separatory funnel and left to stand for 48 hours. Thereafter, when the bottom cock of the separatory funnel was opened, no desorbed water was observed.

For comparison, 1 kg of silica hydrogel produced by reacting sodium silicate and sulfuric acid in the same manner as described above but without the aging procedure by water washing was put into a separatory funnel and left to stand for 48 hours. Thereafter, the bottom cock of the separatory funnel was opened to complete solid-liquid separation, and the amount of desorbed water was measured. The measurement result demonstrated that 50 g of water was separated from the 1 kg of silica hydrogel, i.e., approximately 5 weight percent of water, relative to its own weight before being left to stand, was separated.

The results described above show that, by adding a specific aging treatment after reacting sodium silicate and sulfuric acid, desorption of water from silica hydrogel can be minimized. Therefore, the problem of a significant amount of water desorbed from silica hydrogel gathering in a packaging container may be effectively avoided by preparing a fertilizer containing a treated silica hydrogel as its main component.

[Embodiment 2]

10 kg of silica hydrogel produced in Embodiment 1 was put into a net-like bag and placed at the water inlet to a paddy field. Then, paddy rice was grown according to the customary practices (Silica Hydrogel Section).

For a control comparison, paddy rice was grown according to the conventional method under the same conditions except that silica hydrogel was not introduced at the water inlet (Non-applied Section).

According to the measurement of the silicic acid content of straws in the harvesting stage, the silicic acid content of straws in the Silica Hydrogel Section was increased by approximately 1% as compared with the silicic acid content of the straws in the Non-applied Section. The testing environment and the test results are indicated in Table 1 below.

TABLE 1

| Test Site | Kurashiki-shi, Okayama-ken, Japan | |
|---|---|---|
| Area of Test | 20a | |
| Test Brand | Koshihikari | |
| Growth Condition | Conventional Method | |
| Application Amount | 10 kg | |
| of Silica Hydrogel | | |
| Application Process | Silica hydrogel is put into a net-like bag | |
| | having a size of 30 × 30 cm (the net not | |
| | allowing silica hydrogel to come out), and | |
| | the bag is placed at the water inlet. | |
| Test Results | Silicic Acid Content in Straws in | 9% |
| | Non-applied Section | |
| | Silicic Acid Content in Straws in | 10% |
| | Silica Hydrogel Section | |

[Embodiment 3]

An experiment studying the effects of an application of silica hydrogel on the growth of hydroponic seedlings was performed. Specifically, silica hydrogel was applied to roll mat seedlings to be grown in a hydroponic solution. The experimental conditions are indicated in Table 2 below.

TABLE 2

| | |
|---|---|
| Test Brand | Koshihikari |
| Seeding Amount | 200 g of dried rough rice (corresponding to |
| | a box) |
| Growth Period | May 10, 2001-May 24, 2001 |
| Respective Sections | 90 cm bed per 1 test section, |
| (Common) | 6 liters of culture solution, no repetition |
| Silica Xerogel Section | 300 g of silica gel SiO₂ (99.7%) is placed |
| | under a nonwoven fabric. |
| Silica Hydrogel Section | 1000 g of silica hydrogel containing 30% of |
| | silica (70% of water) is placed under a |
| | nonwoven fabric. |
| Non Silicic Acid Section | only water |
| (Conventional Method | |
| Section) | |

Application of fertilizer was performed only once five days after the seeding by using a mixture of three kinds of commercially available fertilizers (Otsuka House No.1; Otsuka House No.2; Kentaro at the ratio of 4:4:2, all manufactured by Otsuka Chemicals Co. Ltd.) such that the EC (Electric Conductivity) was increased by 2.5 mS/m as compared with water. Examination of the seedlings was performed on 20 seedlings in each section noting the number of leaf blades, the height of seedlings, and other characteristics. On 20 or 100 seedlings measurements were made with respect to the dried weight. Analysis of silicic acid was performed by the gravimetric method (using the sulfuric acid and hydrogen peroxide test method) with respect to the seedlings, and by the molybdenum blue method with respect to the hydroponic culture solution.

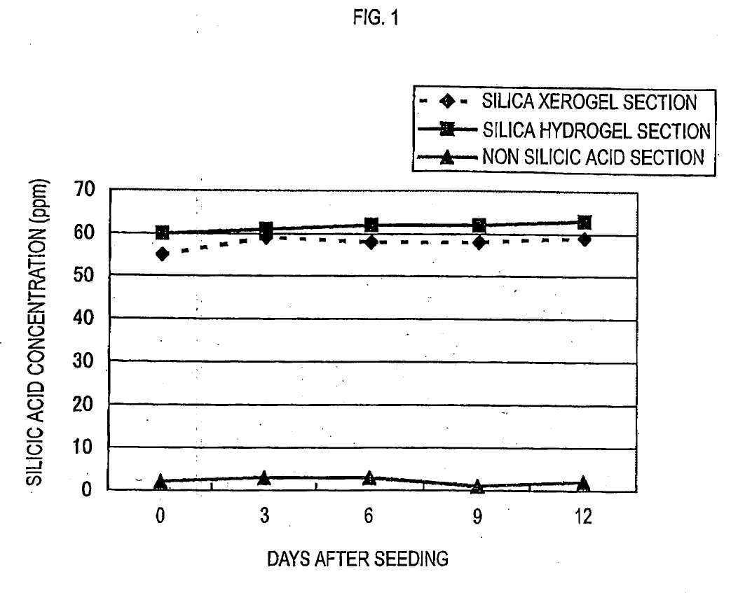

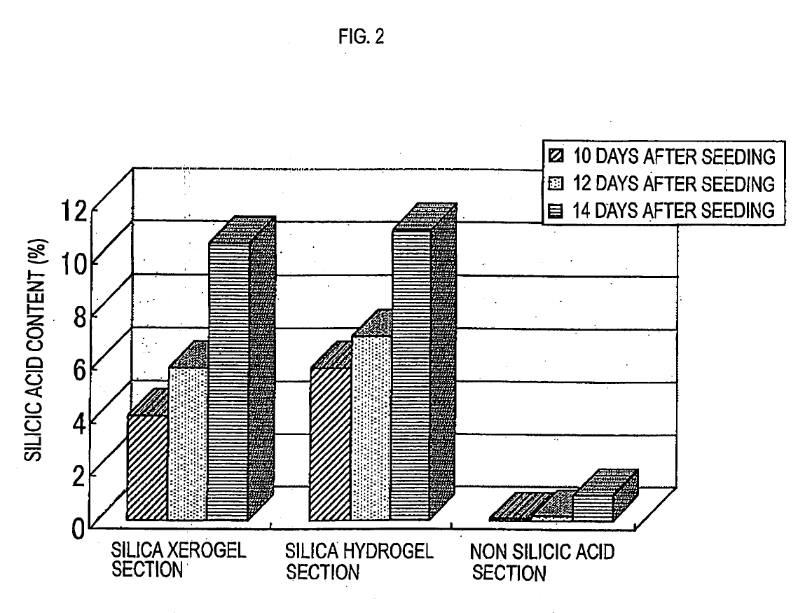

The results of the above experiment demonstrate that when silica hydrogel was applied, the silica concentration in the culture solution was consistently maintained at a high concentration of 50-65 ppm, from the early stage through the late stage of seedling raising (see FIG. 1). The silicic acid content of hydroponic seedlings was increased as the growth progressed to the later stage and exceeded a silicic acid content of 10% after 14 days in the sections which had silica materials applied (see FIG. 2).

After mature growth, the seedlings had no significant difference in the number of leaf blades, the height of the seedlings, or the root length. However, there was a slight tendency for the seedlings to become slightly hardened in the sections for which silica materials were applied (see Table 3 below).

As described above, by applying silica hydrogel, the silica concentration in the culture solution was maintained high. Seedlings were grown having essentially the same number of leaf blades and essentially the same height as seedlings grown using conventional methods. Also characteristic of the seedlings was a high silica content.

TABLE 3

| | | | | | Dried Weight | |
|---|---|---|---|---|---|---|
| | | | | | (g/100 | |
| | | | | | seedlings) | |
| | Number | Height of | Length | | Part | |
| | of Leaf | Seedlings | of Roots | Number | above | Root |
| | Blades | (cm) | (cm) | of Roots | Ground | Part |
| Silica | 3.1 | 10.5 | 5.6 | 6.9 | 0.82 | 0.29 |
| Xerogel | | | | | | |
| Section | | | | | | |
| Silica | 3.2 | 9.9 | 7.4 | 6.3 | 0.81 | 0.27 |
| Hydrogel | | | | | | |
| Section | | | | | | |
| Non | 3.3 | 9.0 | 7.0 | 6.6 | 0.75 | 0.10 |
| Silicic | | | | | | |
| Acid | | | | | | |
| Section | | | | | | |

[Embodiment 4]

500 g of silica hydrogel produced by reacting sodium silicate and sulfuric acid according to a conventional method was placed in beakers to prepare Samples 1-6 under the conditions indicated in Table 4 below.

TABLE 4

| | |
|---|---|
| Sample 1 | no treatment |
| Sample 2 | 20 g of aluminum sulfate dissolved in 500 ml of |
| | water added |
| Sample 3 | 20 g of iron chloride dissolved in 500 ml of water |
| | added |
| Sample 4 | 20 g of calcium chloride dissolved in 500 ml of |
| | water added |
| Sample 5 | 20 g of magnesium chloride dissolved in 500 ml of |
| | water added |
| Sample 6 | 1% of ammonia water added |

After leaving Samples 1-6 at ambient temperature for approximately 30 minutes, a solid-liquid separation was performed using a sieve of 0.3 mm, and then the obtained silica hydrogels were left to stand in airtight containers. After 48 hours, an additional solid-liquid separation was performed, and the amounts of desorbed water were measured. The results are shown in Table 5.

TABLE 5

| | Sample | Sample | Sample | Sample | Sample | Sample |
|---|---|---|---|---|---|---|
| | 1 | 2 | 3 | 4 | 5 | 6 |
| Amount of | 31.2 | 8.5 | 10.3 | 13.8 | 15.2 | 2.6 |
| Desorbed | | | | | | |
| Water after 48 | | | | | | |
| Hours (g) | | | | | | |

The above results show that when silica hydrogel is obtained by reacting sodium silicate and sulfuric acid and then placed in contact with a water solution containing the above listed specific positive ions, water desorption from silica hydrogel can be significantly reduced. Thus, a fertilizer containing such treated silica hydrogel as the main component will minimize the problem of a large amount of desorbed water gathering in packaging containers, such as commonly occurs with untreated silica hydrogel.

[Embodiment 5]

The next experiment concerned the processing of the silica hydrogel produced in Embodiment 1 into a paste state or a slurry state.

First, 2 kg of silica hydrogel and either 1.8 kg or 3.6 kg of water were weighed. Then, an operation was performed to continuously introduce measured amounts into a pigment mill (T.K. COLLOID MILL produced by TOKUSHU KIKA KOGYO CO., LTD.) while checking the state of pulverization through the supply port of the pigment mill. The rotational frequency of the pigment mill was set to one of two different speeds, 6 rpm and 60 rpm.

After the first pulverization was completed, the obtained mixture of silica hydrogel and water was again put into the pigment mill through the supply port to perform a second pulverization. Finally, the obtained mixture of silica hydrogel and water of the second pulverization was again put into the pigment mill through the supply port to perform a third pulverization.

In the above processing procedure, the viscosity of the mixture of silica hydrogel and water was measured at the end of each pulverization, for both cases of 1.8 kg of water and 3.6 kg of water. The resulting measurements are shown in Table 6 below.

TABLE 6

| Silica | | Number of | | |
|---|---|---|---|---|
| Hydrogel (kg) | Water (kg) | Pulverization | Viscosity | |
| 2 | 1.8 | 1 | 6 rpm | 88100 |
| | | | 60 rpm | 6340 |
| | | | T.I. Value | 13.9 |
| | | 2 | 6 rpm | — |
| | | | 60 rpm | 9810 |
| | | | T.I. Value | — |
| | | 3 | 6 rpm | — |
| | | | 60 rpm | — |
| | | | T.I. Value | — |
| 2 | 3.6 | 1 | 6 rpm | 3400 |
| | | | 60 rpm | 540 |
| | | | T.I. Value | 6.3 |
| | | 2 | 6 rpm | 4400 |
| | | | 60 rpm | 570 |
| | | | T.I. Value | 7.7 |
| | | 3 | 6 rpm | 4900 |
| | | | 60 rpm | 610 |
| | | | T.I. Value | 8.0 |

(—) beyond the measurement limit or uncalculable

As demonstrated by Table 6, the silica hydrogel produced in Embodiment 1 may be adjusted so as to have a given viscosity. These results mean that the silica hydrogel can be processed easily into a paste fertilizer or a liquid fertilizer.

Therefore, various applications of the silica hydrogel may be enabled by processing the silica hydrogel into a variety of forms, such as processing into a paste fertilizer to be directly poured at the root of a crop (a local fertilizer application), processing into a liquid fertilizer to be directly sprayed on the leaf surfaces with a spray gun, or dispersing or dissolving into a hydroponic culture solution.

Although the present invention has been described with respect to the preferred embodiments, the present invention is not limited to these embodiments but can be variously modified within the scope of the invention.

What is claimed is:

1. A fertilizer comprising as a main component, a silica hydrogel, wherein the silica hydrogel is obtained by reacting an alkali silicate solution and a mineral acid and is aged by water washing under the conditions of a pH range of pH 4-8 and a temperature range of 40-100° C.

2. A fertilizer as set forth in claim 1, wherein the fertilizer is wet pulverized to be in a paste state

3. A fertilizer as set forth in claim 1, wherein the pH range is pH 6-8 and the temperature range is 60-85° C.

4. A fertilizer as set forth in claim 3, wherein the fertilizer is wet pulverized to be in a paste state.

5. A fertilizer as set forth in claim 1, wherein the pH range is pH 4-8, the temperature range is 40-100° C., and an additional final pH range of pH 2-6.

6. A fertilizer as set forth in claim 5, wherein the fertilizer is wet pulverized to be in a paste state.

7. A fertilizer comprising, as a main component, a silica hydrogel, wherein the silica hydrogel is obtained by reacting an alkali silicate solution and a mineral acid and is subsequently contacted with a solution containing one or more kinds of ions selected from the group consisting of iron ions, magnesium ions, calcium ions, aluminum ions, and ammonia ions.

8. A fertilizer as set forth in claim 7, wherein the fertilizer is wet pulverized to be in a paste state.

9. A method of manufacturing a fertilizer by;
obtaining a silica hydrogel by reacting an alkali silicate solution and a mineral acid;
aging the silica hydrogel by water washing under the conditions of a pH range of pH 4-8 and a temperature range of 40-100° C.; and
preparing the fertilizer comprising the aged silica hydrogel as a main component.

10. A method as set forth in claim 9, wherein an additional step involves wet-pulverizing the fertilizer to be in a paste state.

11. A method as set forth in claim 9, wherein the pH range is pH 6-8 and the temperature range is 60-85° C.

12. A method as set forth in claim 11, wherein an additional step involves wet pulverizing the fertilizer to be in a paste state.

13. A method as set forth in claim 9, wherein a subsequent step in the aging process involves final washing after changing the pH range to a range of pH 2-6.

14. A method as set forth in claim 13, wherein an additional step involves wet pulverizing the fertilizer to be in a paste state.

15. A method of manufacturing a fertilizer by:
obtaining a silica hydrogel by reacting an alkali silicate solution and a mineral acid;
contacting the silica hydrogel with a solution containing one or more kinds of ions selected from the group consisting of iron ions, magnesium ions, calcium ions, aluminum ions, and ammonia ions; and
preparing the fertilizer comprising the silica hydrogel as a main component.

16. A method as set forth in claim 15, wherein a subsequent step involves wet pulverizing the fertilizer to be in a paste state.
